(19) United States
(12) Patent Application Publication
(10) Pub. No.: US 2009/0064216 A1
(43) Pub. Date: Mar. 5, 2009

(54) Optical disc apparatus

(75) Inventors: Yosuke Ishizuka, Kawasaki (JP); Shinsuke Takatsuka, Hitachinaka (JP); Koji Matsumoto, Ichikawa (JP)

Correspondence Address: MCDERMOTT WILL & EMERY LLP, 600 13TH STREET, N.W., WASHINGTON, DC, 20005-3096, US

(73) Assignee: HITACHI-LG DATA STORAGE, INC.

(21) Appl. No.: 12/071,619

(22) Filed: Feb. 25, 2008

(30) Foreign Application Priority Data
Aug. 31, 2007 (JP) 2007-226008

(51) Int. Cl. G11B 7/08

(52) U.S. Cl. 720/689

(57) ABSTRACT

In order to make a unit mechanical portion lighter and to cut down the cost of the unit mechanical portion in an optical disc apparatus, the optical disc apparatus of the present invention is configured to include: a chassis which includes a supporting portion that supports an optical pickup, a pickup moving mechanism, and a disc motor, and coupling portions that abut on and are coupled to a tray at plural points, which is formed of a synthetic resin material, and in which the supporting portion and the coupling portions are integrated with each other; and a flexible flat cable which electrically couples between a first circuit substrate fixed to the bottom case side and a second circuit substrate fixed to the tray or the chassis side, and which is arranged between a bottom cover and a bottom case while its plane surface is folded in a state where the tray is inserted into an apparatus body.

### CLAIM OF PRIORITY

The present application claims priority from Japanese application serial No. P2007-226008, filed on Aug. 31, 2007, the content of which is hereby incorporated by reference into this application.

### BACKGROUND OF THE INVENTION

1. Technical Field

The present invention relates to an optical disc apparatus, and particularly to a configuration of a chassis which supports a disc motor and the like.

2. Description of the Related Art

Development of a thinner optical disc apparatus has recently been advanced so as to make the apparatus much thinner and lighter and to cut down the cost of the apparatus in response to diversification of its applications. For example, in an optical disc apparatus configured in such a manner that a unit mechanical portion is coupled to a tray, and the unit mechanical portion is moved together with the tray at the time of inserting or discharging a disc through the tray, it has been studied to make much lighter a chassis and to cut down the cost of the chassis which supports a disc motor, an optical pickup, and the like in the unit mechanical portion.

As techniques described in patent documents as conventional techniques relating to the present invention, techniques described in, for example, JP-A No. 2002-124071, JP-A No. 2007-4866, and JP-A No. 2000-357388 are given. In JP-A No. 2002-124071 and JP-A No. 2007-4866, there is described a configuration in which a chassis (base) on which a spindle motor is mounted is coupled to a tray through vibration-proofing rubbers (vibration-proofing members). In JP-A No. 2000-357388, there is described a configuration in which a buffer portion formed of a rubber-like elastic body is provided between a mechanical chassis and a chassis frame so as to be planarly integrated.

### SUMMARY OF THE INVENTION

FIGS. 8 to 11B show configuration examples of a conventional thin optical disc apparatus 100′. FIG. 8 shows a plane configuration of the optical disc apparatus 100′ on the front surface side (the side where an optical disc is mounted) (the +Z axis direction side), and is a view showing a state in which a top cover is removed. FIG. 9 is a perspective view showing a state in which a tray 6′ is pulled out from a bottom case 50′ of an apparatus body. FIG. 10 is a configuration view of the tray 6′ and a chassis 5′ viewed from the rear surface side (the −Z axis direction side) of the optical disc apparatus 100′. FIGS. 11A and 11B are cross sectional views of a coupling configuration between the tray 6′ and the chassis 5′.

In the optical disc apparatus 100′, an optical pickup 4′, a pickup moving mechanism, and a disc motor 3′ are mounted on a chassis 5′ of a unit mechanical portion (FIGS. 8 and 9), the chassis 5′ is coupled to a tray 6′ through vibration-proofing members (dampers) at three positions A, B, and C (FIGS. 8, 10, 11A and 11B). Specifically, the unit mechanical portion is coupled to the tray 6′ through the vibration-proofing members (dampers) at the chassis 5′ that configures a part of the unit mechanical portion. In FIGS. 8 and 9, the reference numeral 3a′ denotes a turntable on which an optical disc is mounted, 3b′ denotes a damper which is inserted into a center hole of the optical disc (not shown) so as to clamp the optical disc, 8′ denotes a flexible printed circuit board (FPC) which couples between the optical pickup 4′ and a circuit substrate (not shown) on the unit mechanical portion, 50′ denotes a bottom case which covers the apparatus from the rear surface side (the −Z axis direction side), and 51′ denotes a rail member which is slidably engaged with an outer lateral end of the tray 6′ to be moved in the ±X axis direction in accordance with the discharging and inserting of the tray 6′. The chassis 5′ is coupled to the tray 6′ through the dampers at the three positions A, B, and C in each configuration shown in FIGS. 11A and 11B. Specifically, the chassis 5′ is coupled to the tray 6′ at the position A through a damper A 11a as a vibration-proofing member (FIG. 11A). The chassis 5′ is coupled to the tray 6′ at the position C through a damper C 11c as a vibration-proofing member (FIG. 11B). Although not shown in the drawing, the chassis 5′ is coupled to the tray 6′ at the position B in the same configuration as the position C. The chassis 5′ is supported, through the damper A 11a, at a position having a height hₐ′ from a tray surface Sa at the position A, and a rib 13a as a protrusion portion which protrudes in the chassis 5′ direction is provided to the tray 6′ around the damper A 11a. A gap with a distance gₐ′ is formed between a tip surface Ca of the rib 13a and the chassis 5′ (FIG. 11A). The chassis 5′ is supported, through the damper C 11c, at a position having a height h_{c}′ from a tray surface Sc at the position C. Any protrusion portion is not provided around the damper C 11c (FIG. 11B). The chassis 5′ is configured by, for example, a steel plate having a thickness of about 1.0×10⁻³ m. Further, inside the bottom case 50′, the bottom cover 40′ is fixed to the tray 6′ side at the three positions A, B, and C through screws 30, and end surfaces (an end surface Aa′ in the case of the damper A 11a and an end surface Ac′ in the case of the damper C 11c) on the −Z axis direction side of the dampers are supported at the three positions by a plane surface of the bottom cover 40′, and end surfaces (an end surface Ba′ in the case of the damper A 11a and an end surface Bc′ in the case of the damper C 11c) on the +Z axis direction side are supported by a plane surface of the tray 6′.

Further, each of the dampers is configured by, for example, a cylindrical elastic member (for example, butyl rubber or the like), the chassis 5′ is engaged with grooves (a groove Ga in the case of the damper A 11a and a groove Gc in the case of the damper C 11c) formed at the outer circumferences of the dampers, and into center holes (a center hole Pa in the case of the damper A 11a and a center hole Pc in the case of the damper C 11c) of the dampers, corresponding damper engaging portions of the tray 6′ are inserted and engaged (a damper engaging portion A 12a is engaged with the center hole Pa of the damper A 11a and a damper engaging portion C 12c is engaged with the center hole Pc of the damper C 11c). Accordingly, the chassis 5′ is coupled to the tray 6′ through the respective vibration-proofing members (dampers). In the chassis 5′, the portions to be engaged with the respective dampers are formed in a concave shape having opening portions Fa, Fb, and Fc (FIG. 10), and the concave portions of the chassis 5′ are incorporated into the grooves formed at the outer circumferences of the dampers from the opening portions Fa, Fb, and Fc, so that the chassis 5′ is engaged with the dampers.

Further, as shown in FIG. 9, a main circuit substrate 85′ of the apparatus and a flexible printed circuit board (FPC) 80′ which couples between the main circuit substrate 85′ and a circuit substrate (not shown) on the unit mechanical portion are attached to a flat inner surface 50a′ of the bottom case 50′. Especially, the flexible printed circuit board (FPC) 80′ is formed to have a U-shaped plane surface, and one portion 80a′ of the U-shaped plane surface is fixed on the flat inner surface 50a′ of the bottom case 50′. The disc motor 3′ is attached to the chassis 5′ on the rear surface side (the −Z axis direction side) through a motor fixing plate (not shown). There is provided a bottom cover 40′ fixed to a surface opposite to a disc mounting surface of the tray 6′ under (the −Z axis direction) the motor fixing plate. The bottom cover 40′ has a configuration of a flat plate which covers the lower side of the unit mechanical portion. When the tray 6′ is discharged or inserted from/into the bottom case 50′, the bottom cover is moved, together with the tray 6′, on the upper side of the one portion 80a′ of the flexible printed circuit board (FPC) 80′ through a gap with a predetermined dimension. The reference numeral 10′ denotes a front panel coupled to the tray 6′.

In such a conventional configuration, three vibration-proofing members (dampers) are necessary in order to couple the chassis 5′ to the tray 6′. When assembling the apparatus, the three vibration-proofing members (dampers) are incorporated into the concave portions of the chassis 5′ from the opening portions Fa, Fb, and Fc. Thereafter, into the center holes (Pa in the case of the damper A 11a and Pc in the case of the damper C 11c) of the respective vibration-proofing members (dampers), the corresponding damper engaging portions of the tray 6′ are inserted and engaged after adjusting the attitudes and positions of the respective vibration-proofing members (dampers). Therefore, the number of components of the apparatus becomes large, and a period of time required for assembling becomes long due to the large number of assembling steps including the adjustment. Thus, it is difficult to cut down the cost of the apparatus. Further, in the case where the chassis 5′ is configured by metal, for example, a steel plate, the weight of the chassis 5′ is as heavy as 17×10⁻³ to 20×10⁻³ kg, which makes it difficult to make the apparatus lighter. Furthermore, in the conventional configuration, the cost of the flexible printed circuit board (FPC) 80′ is high because it is configured in a U-shape and the plane area thereof is large. Also from this viewpoint, it is difficult to cut down the cost of the apparatus.

Even in the techniques described in JP-A No. 2002-124071 and JP-A No. 2007-4866, it is conceivable that the circumstances are the same as those in the case of the optical disc apparatus 100′. The technique described in JP-A No. 2000-357388 is not a technique for coupling the mechanical chassis to the tray. In addition, since the mechanical chassis is configured by a material different from that of the rubber-like elastic body which is planarly integrated with the mechanical chassis, it is necessary to control materials and steps in response thereto in manufacturing the apparatus. Thus, it is conceivable that this fact also becomes a factor to hinder the cut-down of the cost.

Further, in a blue-system laser optical disc such as a BD (Blu-ray Disc) and an HD-DVD, a working distance is short. Accordingly, the optical disc apparatus performs recording or reproducing of information in a state where a distance (opposed gap) between a tip end of the objective lens of the optical pickup and a surface on the recording-face side of the optical disc is made shorter. Therefore, in the case where, for example, an impact force or the like is applied to the apparatus and the optical pickup and the optical disc are largely oscillated during a recording or reproducing operation, a protector portion at a tip end of the objective lens is brought into contact with a disc surface being rotated, so that the optical disc surface is likely to be scratched. For example, in the configuration like the conventional optical disc apparatus 100′ in which the chassis made of metal is coupled to the tray through the dampers configured by an elastic member, when an impact force or the like is applied to the apparatus, the unit mechanical portion including the chassis and the optical pickup, and the optical disc are likely to oscillate with a large amplitude relative to the tray. The oscillation of the unit mechanical portion excites the oscillation with a phase different from that of the optical disc for the optical pickup that is mounted inside.

In view of the foregoing circumstances of the conventional techniques, a problem of the present invention is to further cut down the cost of an optical disc apparatus and to make the apparatus much lighter, and to prevent the oscillation of an optical pickup and an optical disc even when an impact force or the like is applied.

An object of the present invention is to provide an optical disc apparatus by which the above-described problem can be solved.

The present invention is the technique by which the above-described problem can be solved and the above-described object can be achieved.

An optical disc apparatus according to one aspect of the present invention is configured to include a chassis which includes (1) a supporting portion that supports an optical pickup, a pickup moving mechanism, and a disc motor, and coupling portions that abut on and are coupled to a tray at plural points, and in which the supporting portion and the coupling portions are formed of the same synthetic resin material and are integrated with each other. Further, an optical disc apparatus according to another aspect of the present invention is configured to include: (2)(a) a chassis which includes a supporting portion that supports an optical pickup, a pickup moving mechanism, and a disc motor, and coupling portions that abut on and are coupled to a tray at plural points, which is formed of a synthetic resin material, and in which the supporting portion and the coupling portions are integrated with each other; and (b) a flexible flat cable which electrically couples between a first circuit substrate fixed to the bottom case side and a second circuit substrate fixed to the tray or the chassis side, and which is arranged between a bottom cover and a bottom case while its plane surface is folded in a state where the tray is inserted into an apparatus body.

### BRIEF DESCRIPTION OF THE DRAWINGS

FIG. 1 is a view of a configuration example of an optical disc apparatus as an embodiment of the present invention and is a perspective view showing a state in which a tray is pulled out from the apparatus body side;

FIG. 2 is a perspective view showing a state of the rear surface side of the optical disc apparatus in FIG. 1 in which a bottom case and a bottom cover are removed;

FIG. 3 is a perspective view of the tray and a chassis viewed from the rear surface side of the optical disc apparatus in FIG. 1;

FIG. 4 is a configuration view on the rear surface side of the chassis in the optical disc apparatus in FIG. 1;

FIG. 5 is a configuration view on the front surface side of the chassis in the optical disc apparatus in FIG. 1;

FIGS. 6A and 6B are cross sectional views, each showing a coupling configuration between the chassis and the tray in the optical disc apparatus in FIG. 1;

FIG. 7 is a view showing a schematic cross-sectional structure of the optical disc apparatus in FIG. 1;

FIG. 8 is a plane configuration view on the front surface side of a conventional optical disc apparatus;

FIG. 9 is a perspective view showing a state in which a tray is pulled out from the apparatus body side in the conventional optical disc apparatus;

FIG. 10 is a configuration view of the tray and a chassis viewed from the rear surface side of the conventional optical disc apparatus; and

FIGS. 11A and 11B are cross sectional views, each showing a coupling configuration between the chassis and the tray in the conventional optical disc apparatus.

### DETAILED DESCRIPTION OF THE PREFERRED EMBODIMENT

Hereinafter, an embodiment of the present invention will be described using the drawings.

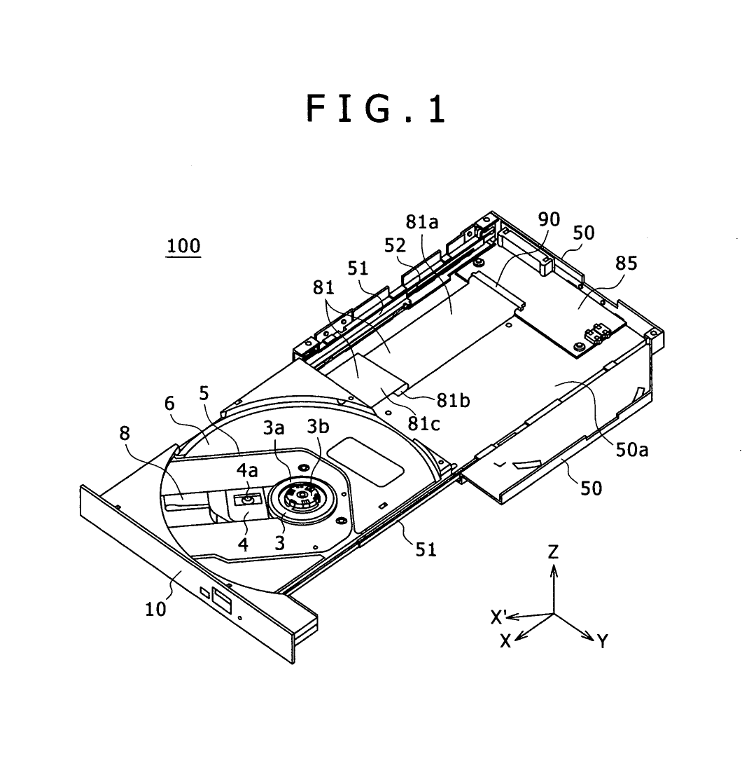

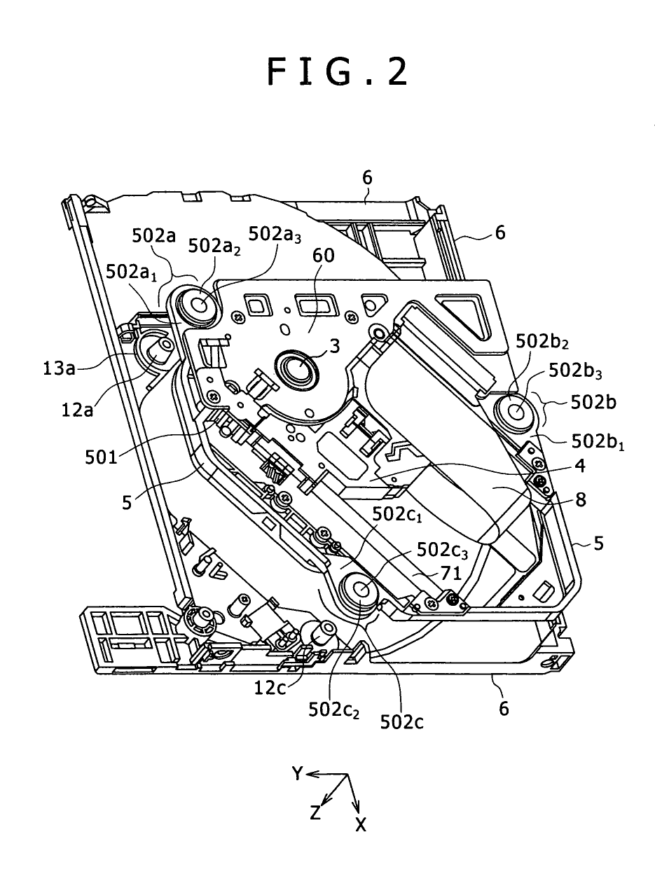

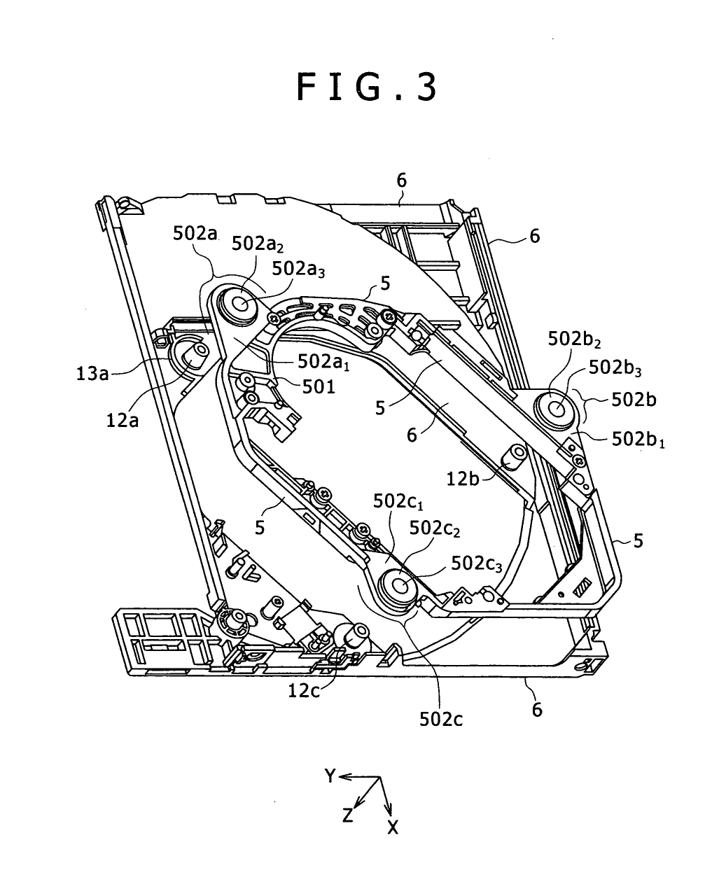

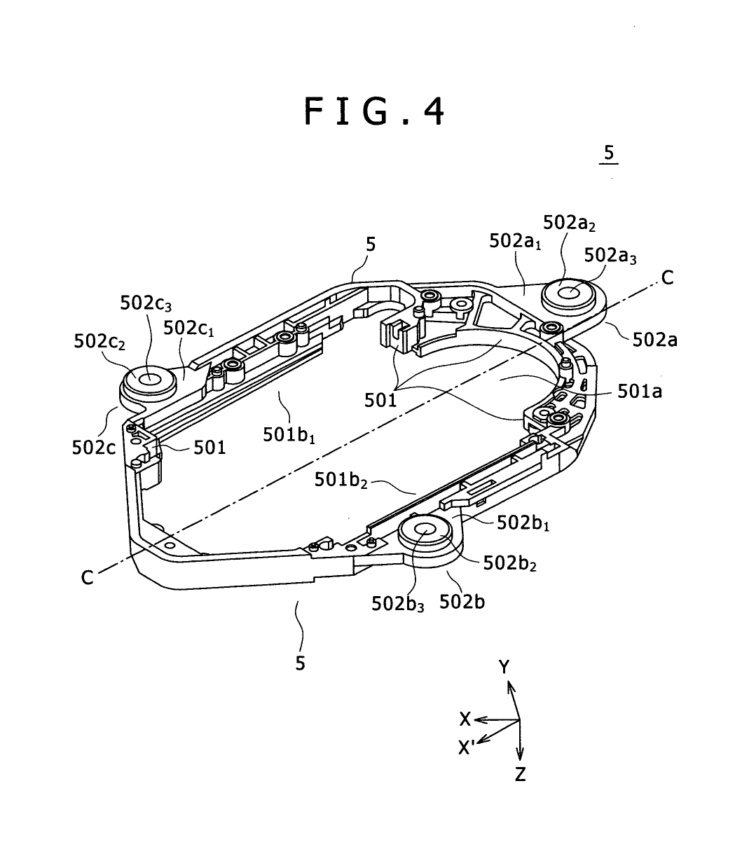

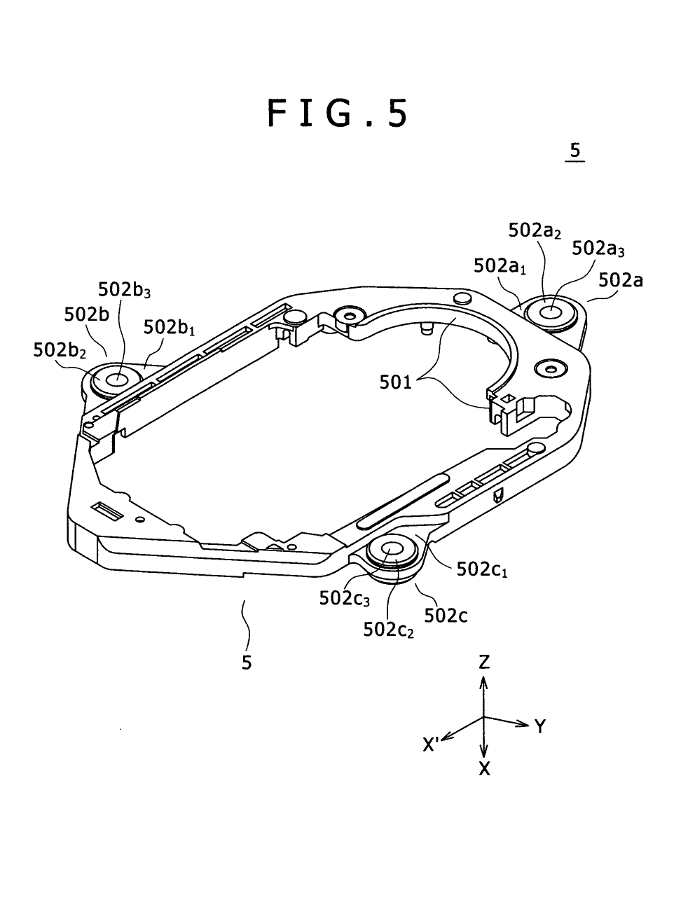

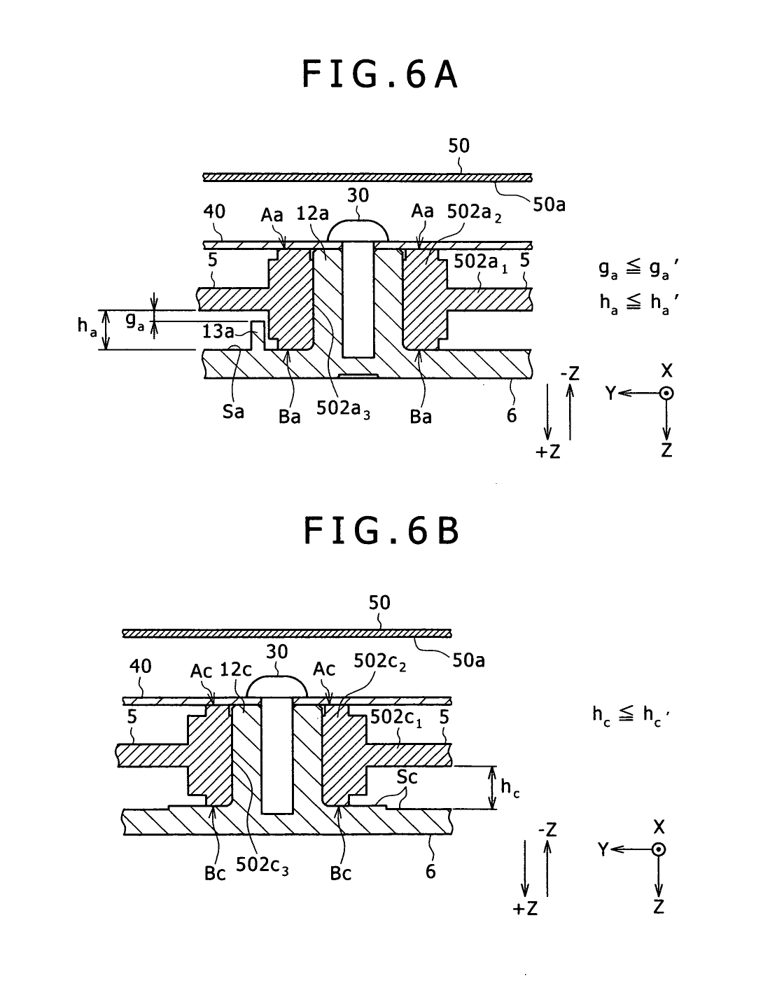

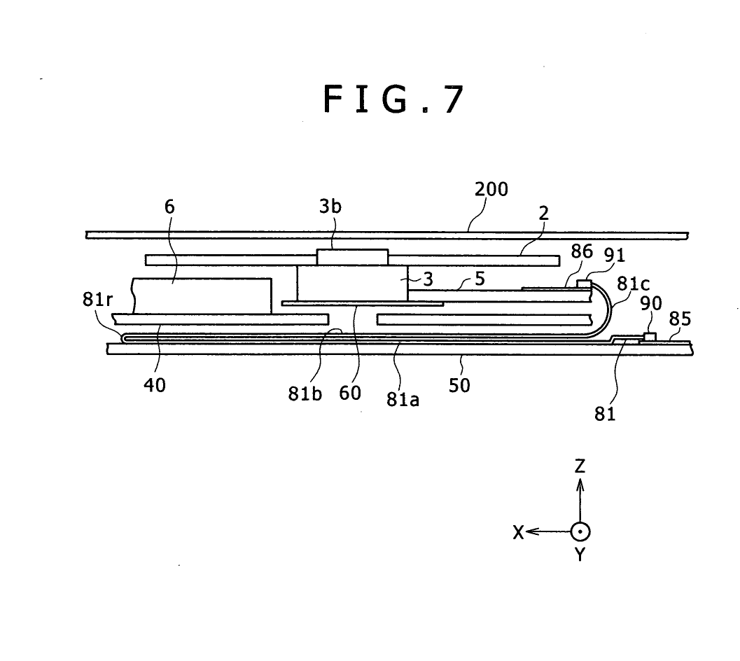

FIGS. 1 to 7 are explanation views according to the embodiment of the present invention. FIG. 1 is a configuration view of an optical disc apparatus as the embodiment of the present invention, and is also a perspective view showing a state in which a tray is pulled out from an apparatus body. FIG. 2 is a perspective view showing a state of the rear surface side of the optical disc apparatus in FIG. 1 in which a bottom case and a bottom cover are removed. FIG. 3 is a perspective view of the tray and a chassis viewed from the rear surface side of the optical disc apparatus in FIG. 1. FIG. 4 is a configuration view on the rear surface side of the chassis in the optical disc apparatus in FIG. 1. FIG. 5 is a configuration view on the front surface side of the chassis in the optical disc apparatus in FIG. 1. FIGS. 6A and 6B are cross sectional views, each showing a coupling configuration between the chassis and the tray in the optical disc apparatus in FIG. 1. FIG. 7 is a view showing a schematic cross-sectional structure of the optical disc apparatus in FIG. 1.

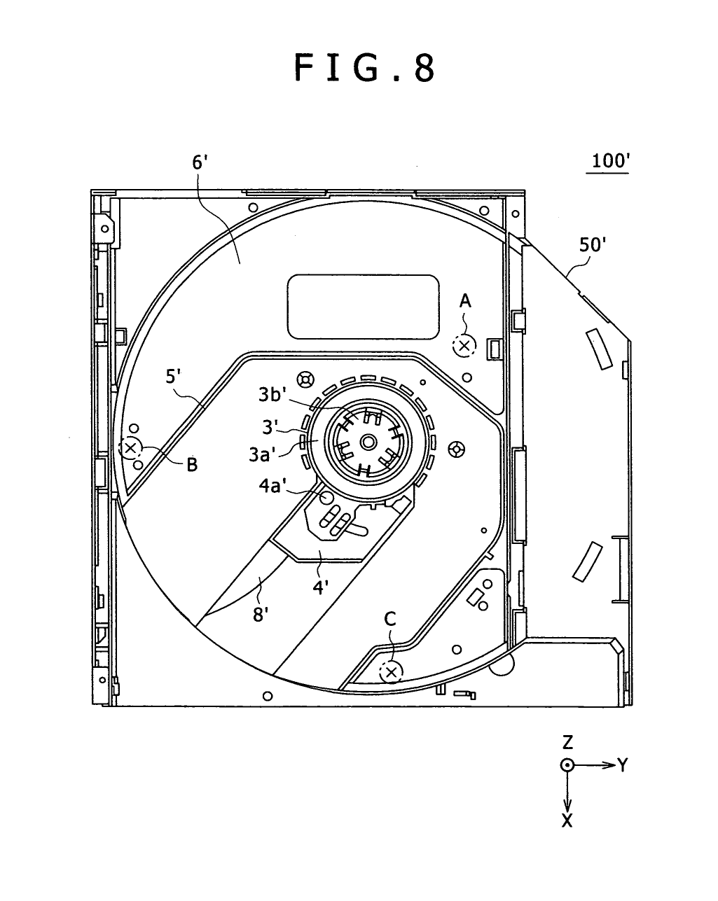

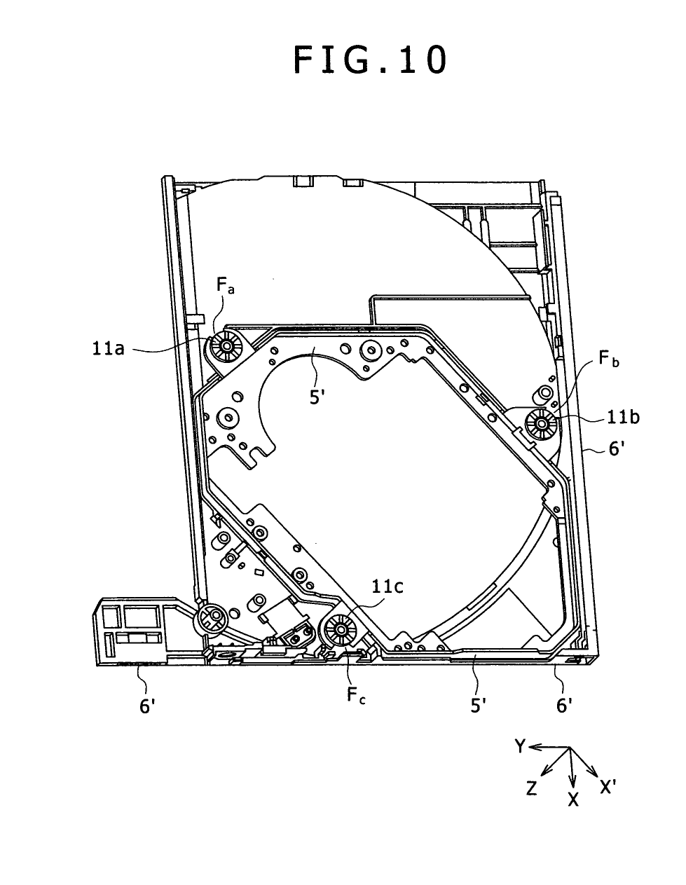

In FIG. 1, the reference numeral 100 denotes an optical disc apparatus as an embodiment of the present invention, 3 denotes a disc motor which drives an optical disc (not shown) as a recording medium to rotate, 3a denotes a turntable, 3b denotes a damper which clamps the optical disc, 4 denotes an optical pickup which irradiates a laser beam onto the optical disc and receives its reflection light, and 4a denotes an objective lens. The optical pickup 4 is moved in a substantially radius direction (the ±X′ direction in FIG. 1) of the optical disc by a pickup moving mechanism (not shown). The pickup moving mechanism includes a lead screw member (not shown) which has a screw on its surface and which allows the optical pickup 4 to be moved in the ±X′ axis direction by rotating the screw, a guide member (not shown) which guides the movement of the optical pickup 4, and a feed motor (not shown) which drives the lead screw member to rotate. The reference numeral 5 denotes a chassis in which the optical pickup 4, the pickup moving mechanism, the disc motor 3, and the like are mounted, 6 denotes a tray which is coupled to the chassis 5 so as to insert the optical disc into the apparatus body of the optical disc apparatus 100 or discharge the optical disc from the apparatus body, and 10 denotes a front panel which is coupled to the tray 6. The disc motor 3 is coupled to the chassis 5 through a plate-like motor fixing plate (not shown). Specifically, the disc motor 3 is fixed to the motor fixing plate, and the motor fixing plate is fixed to the chassis 5. The optical pickup 4, the pickup moving mechanism, the disc motor 3, the chassis 5, and the motor fixing plate configure a unit mechanical portion of the optical disc apparatus 100. Each of the tray 6 and the chassis 5 is configured by synthetic resin, and is formed by a molding process. For example, the tray 6 is configured by modified polyphenylene ether resin and the like, and the chassis 5 is configured by modified polyphenylene oxide resin and the like. The chassis 5 configures an outer circumferential portion of the unit mechanical portion as a base of the unit mechanical portion, and is coupled to the tray 6 at three positions (three positions A, B, and C same as the case of the optical disc apparatus 100′) of the optical disc apparatus 100, as similar to the chassis 5′ in the optical disc apparatus 100′ described using FIGS. 8 and 10. Specifically, the chassis 5 is coupled to the tray 6 at the three positions A, B, and C in the optical disc apparatus. It should be noted that, unlike the chassis 5′, the chassis 5 is coupled to the tray 6 in a state where a part of the chassis body structure directly abuts on the corresponding portions of the tray 6 at the three positions A, B, and C without interposing the dampers (not shown in FIG. 1). In addition, a bottom cover (not shown) which covers the lower side of the unit mechanical portion is provided under (the −Z axis direction) the motor fixing plate. A plane surface of the bottom cover is coupled to a surface of the tray 6 opposite to a disc mounting surface while being in substantially parallel to a plane surface of the motor fixing plate. Further, a bottom case which covers the rear surface side of the apparatus is arranged outside the bottom cover. The reference numeral 50 denotes the bottom case. In the optical disc apparatus 100, it is assumed that the bottom cover and the bottom case are arranged at the same positions as the bottom case 50′ and the bottom cover 40′ in the optical disc apparatus 100′.

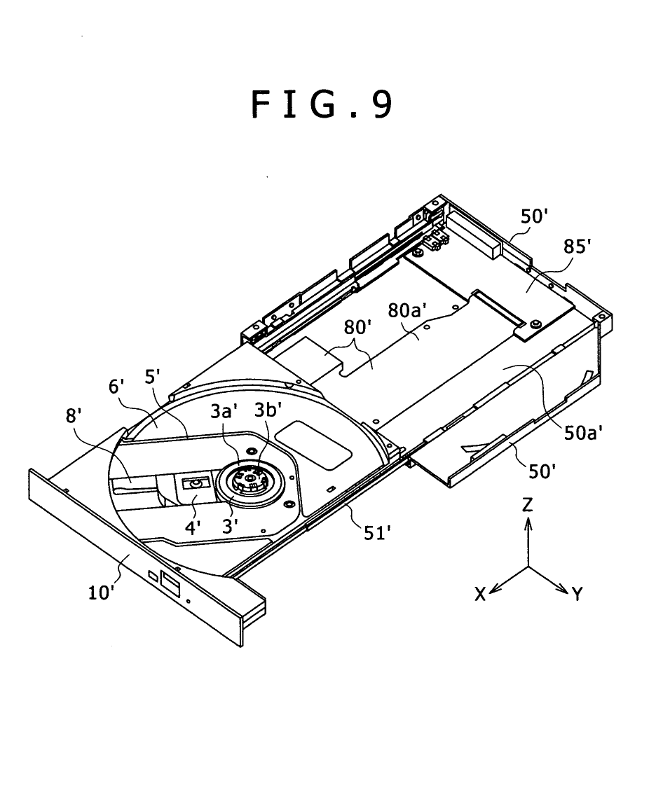

Further, in FIG. 1, the reference numeral 8 denotes a flexible printed circuit board (FPC) which couples between the optical pickup 4 and a circuit substrate (not shown) on the unit mechanical portion, 50 denotes a bottom case which is arranged outside in the −Z axis direction relative to the bottom cover to cover the rear surface side of the optical disc apparatus 100, 50a denotes an inner surface of the bottom case 50, 51 denotes a rail member which is slidably engaged with an outer lateral end of the tray 6 to be moved in the ±X axis direction in accordance with the discharging and inserting of the tray 6, 52 denotes a guide rail member which is engaged with the rail member 51 on the outer side to guide the movement of the rail member 51, 85 denotes a main circuit substrate (a first circuit substrate) of the optical disc apparatus 100 which is fixed to the inner surface 50a side of the bottom case 50, 90 denotes a connector, and 81 denotes a band-like flexible flat cable which couples between a circuit substrate (a second circuit substrate) (not shown) which is fixed to the unit mechanical portion side, namely, the chassis 5 and the main circuit substrate 85. The flexible flat cable 81 is arranged between the bottom cover and the bottom case 50 in a state where its linearly-extended plane surface is folded. A plane portion 81a of the band-like plane surface of the flexible flat cable 81 which is arranged on the inner surface 50a of the bottom case 50 is fixed on the inner surface 50a by adhesion or the like, and a folded plane portion 81b is moved in the ±X axis direction in response to a moving operation in the ±X axis direction of the unit mechanical portion attached to the tray 6. In addition, when the folded plane portion 81b is moved in the −X axis direction, a region which is overlapped with the plane portion 81a is increased, and when the folded plane portion 81b is moved in the ±X axis direction, a region which is overlapped with the plane portion 81a is decreased. The cost of the flexible flat cable 81 can be cut down because the plane area of the flexible flat cable 81 can be made narrower as compared to the case of the U-shaped flexible printed circuit board (FPC) 80′ shown in FIG. 9, a wiring pattern is simple, and an inexpensive material can be used for the material of the substrate.

It should be noted that the constituent elements in FIG. 1 used in the following description are given the same reference numerals as the case of FIG. 1.

FIG. 2 is a perspective view showing a configuration of the rear surface side of the optical disc apparatus 100 in FIG. 1 in which the bottom case and the bottom cover are removed.

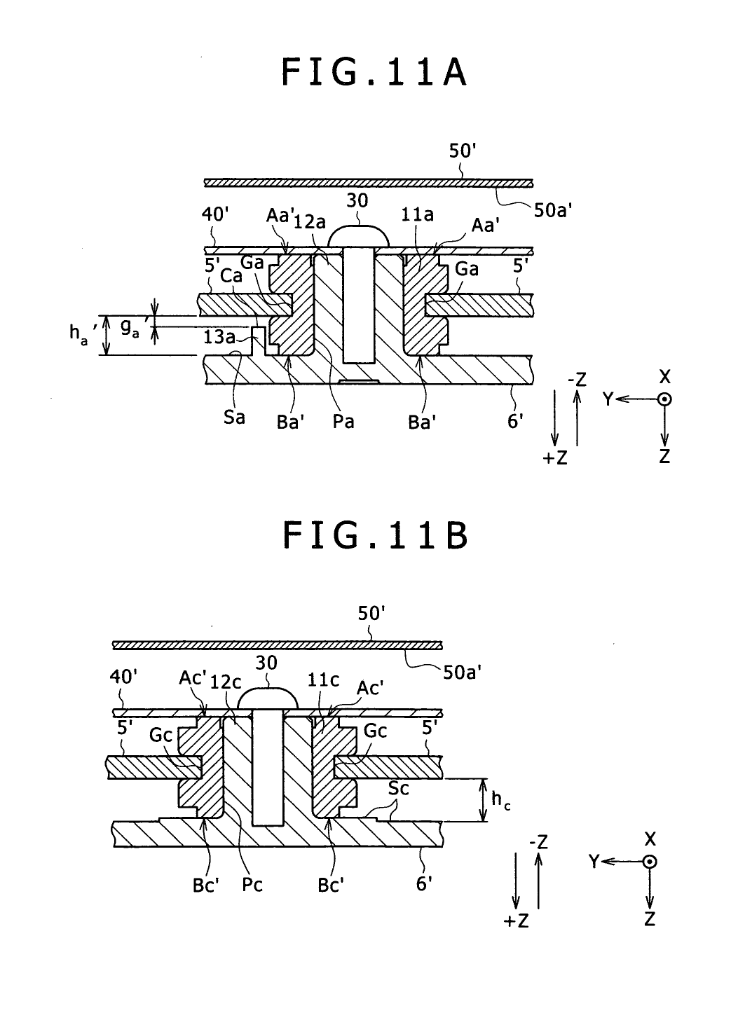

In FIG. 2, the reference numeral 60 denotes a motor fixing plate which is used for fixing the disc motor 3 to the chassis 5 side, and 501 denotes a supporting portion which is a part of the chassis 5 and which supports the optical pickup 4, the pickup moving mechanism, the disc motor 3, the motor fixing plate, and the like. The reference numerals 502a, 502b, and 502c denote coupling portions which are similarly a part of the chassis 5, which are formed at outer circumferential portions of the chassis 5, and which directly abut on and are coupled to the tray 6 at three positions A, B, and C in the optical disc apparatus 100. The chassis 5 is formed by a molding process using a synthetic resin material of one kind. Thus, in the chassis 5, the supporting portion 501 and the coupling portions 502a, 502b, and 502c are formed by using the same synthetic resin material and are integrated with each other. Further, the coupling portion 502a includes a plane-like first portion 502a₁ and a second portion 502a₂ which is continued to the first portion 502a₁ and which protrudes in the rotational axis direction (the ±Z axis direction) of the disc motor 3, and a hole (through-hole) 502a₃ which penetrates in the rotational axis direction (the ±Z axis direction) of the disc motor 3 is provided at the second portion 502a₂. As similar to the above, the coupling portion 502b includes a plane-like first portion 502b₁ and a second portion 502b₂ which is continued to the first portion 502b₁ and which protrudes in the rotational axis direction (the ±Z axis direction) of the disc motor 3, and a hole (through-hole) 502b₃ which penetrates in the rotational axis direction (the ±Z axis direction) of the disc motor 3 is provided at the second portion 502b₂. Further, the coupling portion 502c includes a plane-like first portion 502c₁ and a second portion 502c₂ which is continued to the first portion 502c₁ and which protrudes in the rotational axis direction (the ±Z axis direction) of the disc motor 3, and a hole (through-hole) 502c₃ which penetrates in the rotational axis direction (the ±Z axis direction) of the disc motor 3 is provided at the second portion 502c₂. Each of the reference numerals 12a and 12c denotes a convex portion, as a chassis engaging portion, which protrudes in the −Z axis direction on the tray 6. The chassis engaging portion 12a is inserted into and engaged with the through-hole 502a₃ of the coupling portion 502a of the chassis 5 at the position A, and the chassis engaging portion 12c is inserted into and engaged with the through-hole 502c₃ of the coupling portion 502c of the chassis 5 at the position C. In the tray 6, a rib 13a protruding in the −Z axis direction is provided around the chassis engaging portion 12a, as similar to the case (FIG. 11) of the tray 6′. Further, although not shown in the drawing, the tray 6 is provided with a chassis engaging portion which protrudes in the −Z axis direction and which is inserted into and engaged with the through-hole 502b₃ of the coupling portion 502b of the chassis 5 at the position B. The chassis engaging portion with which the through-hole 502b₃ of the coupling portion 502b is engaged has basically a configuration as a convex portion, as similar to the chassis engaging portion 12c. A screw is provided in the Z axis direction at a tip surface of each of the three chassis engaging portions (convex portions) which are formed in a protruding manner, and the three chassis engaging portions can be fixed to the bottom cover (not shown), by using a screw, which covers the lower side of the unit mechanical portion. The reference numeral 71 denotes a guide member, among the elements configuring the pickup moving mechanism, which guides the movement of the optical pickup 4 in a substantially radius direction of the disc.

It should be noted that the constituent elements in FIG. 2 used in the following description are given the same reference numerals as the case of FIG. 2.

FIG. 3 is a perspective view of the tray 6 and the chassis 5 viewed from the rear surface side of the optical disc apparatus 100 in FIG. 1.

In FIG. 3, the reference numeral 12b denotes the chassis engaging portion which is formed on the tray 6 at the position B in the optical disc apparatus 100. The chassis engaging portion 12b is inserted into and engaged with the through-hole 502b₃ of the coupling portion 502b of the chassis 5.

FIGS. 4 and 5 are views of the chassis 5 alone. FIG. 4 is a configuration view on the rear surface side (the −Z axis direction side) of the chassis 5, and FIG. 5 is a configuration view on the front surface side (the +Z axis direction side) of the chassis 5.

In FIGS. 4 and 5, the chassis 5 is configured as a circular body structure formed in a substantially polygonal shape. The supporting portion 501 which supports the pickup moving mechanism, the disc motor 3, and the like is formed on the circular body structure, and the respective coupling portions 502a, 502b, and 502c coupled to the tray 6 are formed in such a manner that they protrude at the outer circumferential portions on the circular body structure. The respective coupling portions 502a, 502b, and 502c are configured in such a manner that the second portions (502a₂, 502b₂, and 502c₂) are larger in thickness than the first portions (502a₁, 502b₁, and 502c₁). The reference numeral 501a denotes a region where the disc motor 3 is arranged, and 501b₁ and 501b₂ denote regions where the pickup moving mechanism is arranged. The optical pickup 4 is supported by the pickup moving mechanism, and is arranged between the regions 501b₁ and 501b₂ while being movable in the ±X′ axis direction. In the chassis 5, the coupling portion 502a is formed at a position on the −X′ axis direction side relative to the rotation center of the disc motor 3 to be mounted, so that the coupling portion 502a is coupled to the tray 6 at the position A in the optical disc apparatus 100. Further, the coupling portions 502b and 502c are formed at positions which are located on the +X′ axis direction side relative to the rotation center of the disc motor 3 and which are located on the both sides of the line c-c that passes through the rotation center in the X′ axis direction, so that the coupling portions 502b and 502c are coupled to the tray 6 at the positions B and C in the optical disc apparatus 100, respectively. End surfaces on the front surface side (the +Z axis direction side) of the second portions 502a₂, 502b₂, and 502c₂ Of the coupling portions 502a, 502b, and 502c abut on plane portions around the chassis engaging portions (convex portions) of the tray 6. Further, the bottom cover is fixed to end surfaces on the rear surface side (the −Z axis direction side) of the second portions 502a₂, 502b₂, and 502c₂ through screws. The chassis 5 can be manufactured by injection-molding of synthetic resin such as modified polyphenylene oxide resin. The weight of the chassis 5 formed of the synthetic resin material is as extremely light as about half that of a chassis configured by, for example, a steel material (SPCC), and the rigidity thereof, including the rigidities of the coupling portions 502a, 502b, and 502c, is as extremely high as 20 times or more those of dampers (for example, the damper A 11a, the damper B 11b, and the damper C 11c) configured by butyl rubber.

FIGS. 6A and 6B are cross sectional views, each showing a coupling configuration between the chassis 5 and the tray 6 in the optical disc apparatus 100 in FIG. 1. FIG. 6A shows a coupling configuration at the position A, and FIG. 6B shows a coupling configuration at the position C.

In FIGS. 6A and 6B, the coupling portion 502a of the chassis 5 is coupled to (engaged with) the chassis engaging portion 12a at the position A in such a manner that the chassis engaging portion 12a of the tray 6 is inserted into the through-hole 502a₃, and the-coupling portion 502c is coupled to (engaged with) the chassis engaging portion 12c at the position C in such a manner that the chassis engaging portion 12c of the tray 6 is inserted into the through-hole 502c₃. In this state, the chassis 5 is coupled to the tray 6 at the position A in such a manner that an end surface Ba on the +Z axis direction side of the second portion 502a₂ of the coupling portion 502a abuts on a tray surface, and the first portion 502a₁ of the coupling portion 502a is accordingly supported at a position having a height hₐ from a tray surface Sa. In addition, the chassis 5 is coupled to the tray 6 at the position C in such a manner that an end surface Bc on the +Z axis direction side of the second portion 502c₂ of the coupling portion 502c abuts on a tray surface, and the first portion 502c₁ of the coupling portion 502c is accordingly supported at a position having a height h_{c} from a tray surface Sc. A rib 13a protruding in the chassis 5 direction is provided at the position A on the tray 6, and a gap with a distance gₐ is formed between a tip surface Ca of the rib 13a and the first portion 502a₁ of the coupling portion 502a of the chassis 5. However, any protrusion portion such as the rib 13a is not provided at the position C on the tray 6. A coupling configuration in which the coupling portion 502b is coupled to the tray 6 at the position B is basically the same as the coupling configuration in which the coupling portion 502c is coupled to the tray 6 at the position C. In the optical disc apparatus 100, since the rigidities of the coupling portions 502a, 502b, and 502c of the chassis 5 are extremely higher than those of the damper A 11a, the damper B 11b, and the damper C 11c formed of butyl rubber in the optical disc apparatus 100′, displacement caused by compression and extension of the respective coupling portions 502a, 502b, and 502c is small even when, for example, an impact force or the like is applied to the apparatus. Therefore, the heights hₐ and h_{c} and the distance gₐ are equal to or smaller in dimension than the heights hₐ′ and h_{c}′ and the distance ga′ in the optical disc apparatus 100′ (hₐ≦hₐ′, h_{c}≦h_{c}′, gₐ≦gₐ′). Inside the bottom case 50 of the optical disc apparatus 100, the bottom cover 40 is fixed to the tray 6 side through screws 30 at the three positions A, B, and C. Specifically, in a state where an end surface Aa on the −Z axis direction side of the second portion 502a₃ of the coupling portion 502a of the chassis 5 abuts on a surface of the bottom cover 40, the bottom cover 40 is fixed to the chassis engaging portion 12a on the tray 6 side through the screw 30 at the position A. In addition, in a state where an end surface Ac on the −Z axis direction side of the second portion 502c₂ of the coupling portion 502c of the chassis 5 abuts on a surface of the bottom cover 40, the bottom cover 40 is fixed to the chassis engaging portion 12c on the tray 6 side through the screw 30 at the position C. At the position B, the bottom cover 40 is fixed as similar to the case of the position C.

FIG. 7 shows a schematic cross-sectional structure at a straight-line position of the X axis direction that passes through the rotation center of the disc motor 3 in the optical disc apparatus 100 in FIG. 1, and also shows a configuration in a state where a recording or reproducing operation is ready to be performed after the optical disc is inserted into the apparatus body through the tray 6.

In FIG. 7, the reference numeral 2 denotes the optical disc, 85 denotes the main circuit substrate (first circuit substrate) of the optical disc apparatus 100 which is fixed to the bottom case 50 side, 90 denotes the connector provided on the main circuit substrate 85, 86 denotes the circuit substrate (second circuit substrate) which is fixed to the unit mechanical portion side, namely, the chassis 5, 91 denotes the connector provided on the circuit substrate 86, 81 denotes the band-like flexible flat cable which couples between the main circuit substrate 85 and the circuit substrate 86 through the connectors 90 and 91, 81a denotes the first plane portion of a plane portion of the flexible flat cable 81 which is arranged on the inner surface of the bottom case 50 to be fixed by adhesion or the like, 81b denotes the second plane portion of a plane portion of the flexible flat cable 81 which is folded to be overlapped with the first plane portion 81a, 81r denotes a folded portion between the first plane portion 81a and the second plane portion 81b, 81c denotes a portion (hereinafter, referred to as a folded portion to be coupled to the connector) between the second plane portion 81b and the connector 91, and 200 denotes a top cover which covers the upper side (the side where the disc is mounted) of the apparatus. The other reference numerals denote the same constituent elements as the case of the other drawings. In such a configuration, the region area of the second plane portion 81b is changed in accordance with a moving operation, in the ±X axis direction, of the unit mechanical portion attached to the tray 6, that is, a moving operation of the tray 6 at the time of inserting or discharging the disc. When the tray 6 is moved in the −X axis direction, the region area of the second plane portion which is overlapped with the first plane portion 81a is increased. When the tray 6 is moved in the +X axis direction, the region area of the second plane portion which is overlapped with the first plane portion 81a is decreased. On the contrary, the region area of the folded portion 81c to be coupled to the connector is decreased when the tray 6 is moved in the −X axis direction, and the region area of the folded portion 81c to be coupled to the connector is increased when the tray 6 is moved in the +X axis direction. FIG. 7 shows a state in which the tray 6 is moved by the maximum distance in the −X axis direction, and the region area of the folded portion 81c to be coupled to the connector at this time is minimum. Therefore, in this state, an elastic restoring force with the maximum degree is generated at the folded portion 81c to be coupled to the connector, and a press-up force towards the upper direction (the Z axis direction) acts on the unit mechanical portion through the connector 91. In the case where the flexible flat cable 81 is thick or wide, or is formed of a rigid material, the rigidity thereof becomes high, thus increasing the press-up force. The chassis 5 is configured in such a manner that the supporting portion and the coupling portions are integrated with each other by molding using a synthetic resin material so as to increase the rigidities of the coupling portions in the optical disc apparatus 100. Accordingly, when the press-up force is large, the displacement of the chassis 5 to the upper direction (the Z axis direction) can be suppressed to a lower level, thus causing no problems. If the chassis 5 is largely displaced to the upper direction (the Z axis direction), it is conceivable that the damper 3b is largely moved in the upper direction (the Z axis direction), and a tip end thereof abuts on an inner surface of the top cover 200 to hinder a normal recording operation or a normal reproducing operation. However, this can be avoided in the optical disc apparatus 100.

According to the optical disc apparatus 100 as the embodiment of the present invention described above, it is possible to further cut down the cost of the apparatus and to make the apparatus much lighter. Further, the impact resistance can be improved. For example, in the case where an impact force or the like is applied to the apparatus at the time of a recording or reproducing operation, the displacement of the chassis 5 in the ±Z axis direction can be suppressed due to small displacement of each coupling portion of the chassis 5. Thus, it is possible to avoid the abutment of the clamper 3b on the top cover 200 and the removal of the optical disc 2 from the clamper 3b caused when the disc motor 3 is sunk on the bottom case 50 side (the −Z axis direction side). The oscillation of the optical pickup 4 and the optical disc 2 accompanied by the impact force or the like can be suppressed to a lower level, and it is possible to easily avoid the contact between a tip end of the objective lens 4a and a disc surface even when recording or reproducing is to be performed onto/from an optical disc having a short working distance, such as a BD. Further, in the optical disc apparatus 100, since the mass of the chassis 5 is small and the rigidity of each coupling portion is high, the resonant frequency of oscillation systems formed by the chassis 5 itself is high. Therefore, a disturbance of a low frequency range can be blocked, and thus the oscillation and noise of the apparatus during a recording or reproducing operation can be suppressed. It has been found by an experiment that the levels of oscillation and noise of the optical disc apparatus 100 can be made substantially equal to those in the case of the conventional optical disc apparatus 100′. Further, in the optical disc apparatus 100, distances between the respective components can be reduced in the ±Z axis direction as compared to the case of the conventional optical disc apparatus 100′, and thus it is possible to make the apparatus much thinner.

According to the present invention, it is possible to further cut down the cost of an optical disc apparatus and to make the apparatus much lighter. Further, it is possible to easily avoid the contact between a tip end of an objective lens and a disc surface even when recording or reproducing is to be performed onto/from an optical disc having a short working distance, such as a BD.

The present invention can be implemented in embodiments other than the above-described embodiment without departing from its spirit or principal characteristics. Therefore, the above-described embodiment is merely an example of the present invention in terms of all aspects, and should not be construed in a limited way. The scope of the present invention is shown by the claims. Further, all of modifications and changes pursuant to a scope equivalent to the scope of the claims are within the scope of the present invention.

What is claimed is:

1. An optical disc apparatus which records or reproduces information onto/from an optical disc, the apparatus comprising:
an optical pickup which irradiates a laser beam onto the optical disc to receive its reflection light;
a pickup moving mechanism which allows the optical pickup to be moved in a substantially radius direction of the optical disc;
a disc motor which drives the optical disc to rotate;
a tray which inserts or discharges the optical disc into/from an apparatus body;
a chassis which includes a supporting portion that supports the optical pickup, the pickup moving mechanism, and the disc motor, and coupling portions that abut on and are coupled to the tray at a plurality of points, which is formed of a synthetic resin material, and in which the supporting portion and the coupling portions are integrated with each other;
a bottom cover which is coupled to a surface opposite to a disc mounting surface of the tray;
a bottom case which is arranged outside the bottom cover to cover the rear surface side of the apparatus; and
a flexible flat cable which electrically couples between a first circuit substrate fixed to the bottom case side and a second circuit substrate fixed to the tray or the chassis side, and which is arranged between the bottom cover and the bottom case while its plane surface is folded in a state where the tray is inserted into the apparatus body.

2. The optical disc apparatus according to claim 1,
wherein the chassis is configured in such a manner that the supporting portion and the coupling portions are formed of the same synthetic resin material.

3. The optical disc apparatus according to claim 1,
wherein the chassis is configured in such a manner that each of the coupling portions includes a plane-like first portion and a second portion which is continued to the first portion and which protrudes in the rotational axis direction of the disc motor.

4. The optical disc apparatus according to claim 1,
wherein a hole which penetrates in the rotational axis direction of the disc motor is formed at each of the coupling portions of the chassis,
the tray has convex portions at portions which are coupled to the coupling portions of the chassis, and
the convex portions are inserted into the through-holes, so that the coupling portions of the chassis are coupled to the tray.

5. The optical disc apparatus according to claim 2,
wherein a hole which penetrates in the rotational axis direction of the disc motor is formed at each of the coupling portions of the chassis,
the tray has convex portions at portions which are coupled to the coupling portions of the chassis, and
the convex portions are inserted into the through-holes, so that the coupling portions of the chassis are coupled to the tray.

6. The optical disc apparatus according to claim 3,
wherein a hole which penetrates in the rotational axis direction of the disc motor is formed at each of the coupling portions of the chassis,
the tray has convex portions at portions which are coupled to the coupling portions of the chassis, and
the convex portions are inserted into the through-holes, so that the coupling portions of the chassis are coupled to the tray.

7. The optical disc apparatus according to claim 1,
wherein the chassis is configured in such a manner that the coupling portions are formed at three points on the outer circumferential portion of the chassis.

8. The optical disc apparatus according to claim 2,
wherein the chassis is configured in such a manner that the coupling portions are formed at three points on the outer circumferential portion of the chassis.

9. The optical disc apparatus according to claim 3,
wherein the chassis is configured in such a manner that the coupling portions are formed at three points on the outer circumferential portion of the chassis.

10. The optical disc apparatus according to claim 4,
wherein the chassis is configured in such a manner that the coupling portions are formed at three points on the outer circumference portion of the chassis.

11. An optical disc apparatus which records or reproduces information onto/from an optical disc, the apparatus comprising:
an optical pickup which irradiates a laser beam onto the optical disc to receive its reflection light;
a pickup moving mechanism which allows the optical pickup to be moved in a substantially radius direction of the optical disc;
a disc motor which drives the optical disc to rotate;
a tray which inserts or discharges the optical disc into/from an apparatus body; and
a chassis which includes a supporting portion that supports the optical pickup, the pickup moving mechanism, and the disc motor, and coupling portions that abut on and are coupled to the tray at a plurality of points, and in which the supporting portion and the coupling portions are formed of the same synthetic resin material and are integrated with each other.
